(19) United States
(12) Patent Application Publication
(10) Pub. No.: US 2024/0161258 A1
(43) Pub. Date: May 16, 2024

(54) SYSTEM AND METHODS FOR TUNING AI-GENERATED IMAGES

(71) Applicant: Shopify Inc., Ottawa (CA)

(72) Inventors: Russ MASCHMEYER, Berkeley, CA (US); Eric Andrew FLORENZANO, San Francisco, CA (US); Brennan LETKEMAN, Calgary (CA); Diego Macario BELLO, Montreal (CA); Daniel BEAUCHAMP, Toronto (CA); Neil Leonard PADGETT, Toronto (CA)

(73) Assignee: Shopify Inc., Ottawa (CA)

(21) Appl. No.: 18/145,160

(22) Filed: Dec. 22, 2022

Related U.S. Application Data
(60) Provisional application No. 63/424,577, filed on Nov. 11, 2022.

(51) Int. Cl. G06T 7/00; G06Q 30/0201; G06T 7/70; G06T 11/00; G06V 10/774

(52) U.S. Cl. CPC G06T 7/0002; G06Q 30/0201; G06T 7/70; G06T 11/00; G06V 10/774; G06T 2207/20081; G06T 2207/20084; G06T 2207/30168; G06T 2207/30196

(57) ABSTRACT

A computer-implemented is disclosed. The method includes: obtaining a first set of a plurality of images of products that are associated with a same product category; selecting a subset of the first set based on interaction data of customer interactions with a merchant's online storefront; and providing, to a deep learning generative model, the subset of the first set and a second set of training images depicting a first product for training a customized generative model associated with the first product.

### CROSS-REFERENCE TO RELATED APPLICATION

The present application claims the benefit of priority to U.S. Provisional Patent Application No. 63/424,577 filed on Nov. 11, 2022, the contents of which are incorporated herein by reference.

### TECHNICAL FIELD

The present disclosure relates to image generation and, in particular, to systems and methods for tuning text-to-image models for subject-driven image synthesis.

### BACKGROUND

Large text-to-image models, such as Stable Diffusion by Stability AI, enable high-quality and diverse synthesis of images from a given text prompt. Text-to-image models generally combine a language model, which transforms input text into a latent representation, and a generative image model, which produces an image based on that representation.

### BRIEF DESCRIPTION OF THE DRAWINGS

Embodiments will be described, by way of example only, with reference to the accompanying figures wherein:

FIG. 1 illustrates an example system for AI-based image generation;

FIG. 2 is a block diagram of an e-commerce platform that is configured for implementing example embodiments of the image generation engine of FIG. 1;

FIG. 3 shows, in flowchart form, an example method for generating subject-driven images based on an image generative model;

FIG. 4 shows, in flowchart form, an example method for customized training of an image generative model;

FIG. 5 shows, in flowchart form, another example method for generating subject-driven images based on an image generative model;

FIG. 6A is a high-level schematic diagram of an example computing device;

FIG. 6B shows a simplified organization of software components stored in a memory of the computing device of FIG. 6A;

FIG. 7 is a block diagram of an e-commerce platform, in accordance with an example embodiment; and

FIG. 8 is an example of a home page of an administrator, in accordance with an example embodiment.

Like reference numerals are used in the drawings to denote like elements and features.

### DETAILED DESCRIPTION OF EMBODIMENTS

In an aspect, the present application discloses a computer-implemented method. The method includes: obtaining a first input for an image generative model; iteratively executing the image generative model to obtain an output image satisfying at least one criterion, the iteratively executing including: obtaining, via the image generative model, an image generated based on an input; determining that the image generated based on the input does not satisfy the at least one criterion; responsive to determining that the image generated based on the input does not satisfy the at least one criterion, modifying the input, wherein the iteratively executing is repeated until an image is obtained based on the first input that satisfies the at least one criterion.

In some implementations, the obtained image that satisfies the at least one criterion may be provided as the output image.

In some implementations, determining that the image generated based on the input does not satisfy the at least one criterion may include using a machine learning model to analyze the image.

In some implementations, the machine learning model may provide an evaluation of an input image corresponding to the at least one criterion.

In some implementations, the machine learning model may be trained to determine at least one of: poses of human subjects in a generated image; an indicator of photorealism associated with the generated image; structural anomalies in subjects in the generated image; or lighting anomalies on the subjects or scene depicted in the generated image.

In some implementations, the machine learning model may be trained to assign aesthetics scores to generated images.

In some implementations, modifying the input may include at least one of modifying a text prompt or changing a seed value associated with the image generative model.

In some implementations, modifications to the text prompt may be determined based on at least one anomaly associated with the image generated based on the input.

In some implementations, modifications to the input may be determined based on a mapping between a set of one or more defined modification text and types of anomalies detectable in images generated via the image generative model.

In some implementations, the method may further include: obtaining, via the image generative model, one or more further output images that are associated with detected anomalies; and determining a pre-processing filter for applying to training image sets that are inputted to the image generative model, the pre-processing filter being constructed based on the further output images.

In some implementations, the pre-processing filter may include an aesthetics scoring model for assigning aesthetics scores to images of a training image set.

In another aspect, the present application discloses a computer-implemented method. The method includes: obtaining a first set of a plurality of images of products that are associated with a same product category; selecting a subset of the first set based on interaction data of customer interactions with a merchant's online storefront; and providing, to a deep learning generative model, the subset of the first set and a second set of training images depicting a first product for training a customized generative model associated with the first product.

In some implementations, the interaction data may include at least one of dwell time data or clickthrough rate data.

In some implementations, the method may further include: receiving a first input; and obtaining, via the customized generative model associated with the first product, a first output image based on providing the first input to the customized generative model.

In some implementations, the first input may include natural language description of a desired output.

In some implementations, the deep learning generative model may be configured to fine-tune a text-to-image diffusion model for training the customized generative model associated with the first product.

In another aspect, the present application discloses a computing system. The computing system includes a processor and a memory coupled to the processor. The memory stores computer-executable instructions that, when executed by a processor, configure the processor to: obtain a first input for an image generative model; iteratively execute the image generative model to obtain an output image satisfying at least one criterion, the iteratively executing including: obtaining, via the image generative model, an image generated based on an input; determining that the image generated based on the input does not satisfy the at least one criterion; responsive to determining that the image generated based on the input does not satisfy the at least one criterion, modifying the input, wherein the iteratively executing is repeated until an image is obtained based on the first input that satisfies the at least one criterion.

In another aspect, the present application discloses a non-transitory, computer-readable medium storing processor-executable instructions that, when executed by a processor, are to cause the processor to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. More specifically, variable product data refers to product data that may be changed automatically or at the discretion of the merchant offering the product.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and any associated payment requests, via an e-commerce platform, and the e-commerce platform may be equipped with transaction/payment processing components or delegate such processing activities to one or more third-party services. An e-commerce platform may be extended by connecting one or more additional sales channels representing platforms where products can be sold. In particular, the sales channels may themselves be e-commerce platforms, such as Facebook Shops™, Amazon™, etc.

### Fine-Tuning Image Generative Models

Recent advances in deep learning have produced generative models that can mimic the appearance of subjects in a reference set and synthesize novel renditions of them in different contexts. These models may sometimes generate images of subjects that are unrealistic. For example, images may depict human subjects in unrealistic poses (e.g., a person wearing a pair of shoes with legs twisted in a physically impossible position) or arrangements (e.g., shoes worn backwards on the feet). As another example, a human subject may be depicted as having an impossible number of limbs, fingers, toes, etc.

Text-to-image models may provide insufficient or flawed image quality assurance of output images. Where the images generated by a model are determined to be deficient, users may need to re-run the model by, for example, changing text prompts multiple times until the output is satisfactory, i.e., until errors or anomalies are no longer detected in the output images.

The present application discloses a “post-processing” quality assurance layer for filtering the output of text-to-image models. The post-processing layer may include machine learning models that are trained to detect realism or anomalies in object composition. Specifically, the output of an initial generative process may be parsed by models trained for detecting various types/categories of anomalies. The models may be trained to, among others: run pose estimation for human subjects present in the output; detect realism in output that is intended to be photorealistic; detect structural anomalies in the subjects (e.g., counts of limbs (and fingers, toes, etc.), skeletal aligning, and the like); detect lighting anomalies on the subjects/scene depicted in the output images; detect anomalies in text or logos depicted in images.

The relevant text-to-image model may be re-run automatically based on results of the post-processing/filtering. Input text to the model may be altered, or tuned, automatically in accordance with desired modifications as determined by the post-processing QA layer. The text prompts that led to output flagged by the QA layer may be identified as problematic. The QA layer may specify modifications as suggestions or recommendations for output images.

Additionally, or alternatively, the post-processing QA layer may perform modifications to output images based on desired filters as specified by the user. For example, upon detecting anomalies in text in an output image (e.g., using optical character recognition), the QA layer may perform a sequence of operations, such as in-painting for removal and subsequently re-drawing text, for editing recognized text in the image.

In some implementations, defective output images of a text-to-image model may be identified during post-processing and said images may be used to build and/or improve a “pre-processing filter” which may be applied to input training images. The input images may be successively refined based on other techniques that are automated.

The present invention also encompasses methods for generating product images that leverage use of text-to-image models. Based on an approach (e.g., Google's DreamBooth) for customizing text-to-image diffusion models, a small set of input training images of a product may be used to fine-tune a pre-trained text-to-image model such that it learns to bind a unique identifier with the specific product. The unique identifier can be used to synthesize novel photorealistic images of the product contextualized in different scenes.

The proposed methods include selecting a regularization set of images to counter overfitting and language drift issues. The regularization images may be selected based on, at least, customer interaction data in connection with online merchant storefronts (e.g., dwell time, rates of clickthrough, conversion, etc.). For a particular subject product, a large set of regularization images (e.g., 200-250 images) of products from a same category as the subject product and a smaller set of training images (e.g., low-quality mobile photos) of the subject product may be used to train models for the subject product. Additionally, the regularization set may be biased towards factors such as merchant and/or images preferences regarding products.

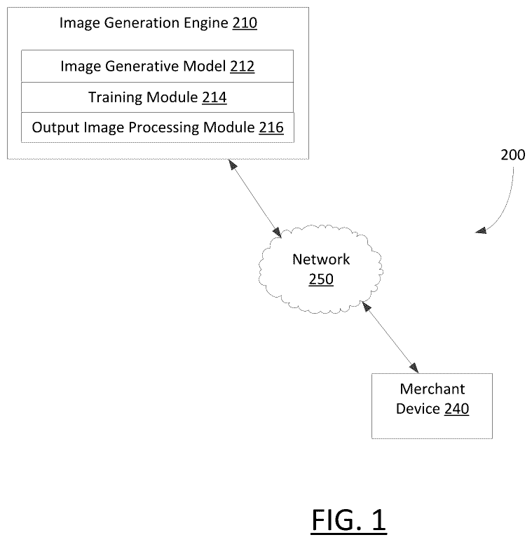

Reference is first made to FIG. 1, which illustrates, in block diagram form, an example system 200 for AI-based image generation. As shown in FIG. 1, the system 200 may include, at least, an image generation engine 210, merchant devices 240, and a network 250 connecting one or more of the components of system 200.

The image generation engine 210 and the merchant devices 240 may communicate via the network 250. The merchant device 240 is a computing device and may take a variety of forms such as, for example, a mobile communication device (e.g., a smartphone), a tablet computer, a wearable computer (e.g., smart glasses, augmented reality/mixed reality headset, etc.), a laptop or desktop computer, or a computing device of another type.

An image generation engine 210 is provided in the system 200. The image generation engine 210 may be a software-implemented component containing processor-executable instructions that, when executed by one or more processors, cause a computing system to carry out some of the processes and functions described herein. In some embodiments, the image generation engine 210 may be provided as a stand-alone service. In particular, a computing system may engage the image generation engine 210 as a service that facilitates customization of image generative models.

The image generation engine 210 supports AI-based generation of images. The image generation engine 210 may be implemented by a computing system. Specifically, a computing system that is configured to process requests to generate or modify images may implement various functions of the image generation engine 210. For example, in the system 200 of FIG. 1, merchants associated with merchant devices 240 may transmit, to a computing system, requests to generate new images or modify existing images. Such requests may include input from the merchants such as, for example, a dataset comprising sample or training images, identities of generative models, text prompts (e.g., natural language description), and other option parameters such as output image dimensions, sampling types, and the like. The image generation engine 210 may process the requests and generate/modify images based on the identified generative model(s) which may, in some embodiments, be a machine learning model such as a text-to-image model. The images may then be provided to the merchants as part of responses to the merchant requests.

As shown in FIG. 1, the image generation engine 210 may include, at least, an image generative model 212, a training module 214, and an output image processing module 216. The modules may comprise software components that are stored in a memory and executed by a processor to support various functions of the image generation engine 210.

The image generative model 212 represents a machine learning model that can be used for generating new images from an existing dataset. Specifically, the image generative model 212 may be a deep learning model based on artificial neural networks. In some embodiments, the image generative model 212 may be a text-to-image model that takes a natural language description as input and produces an image matching the description. An example implementation of the image generative model 212 is Stability AI's Stable Diffusion, which is a latent diffusion model that supports the ability to generate detailed images conditioned on text descriptions. The image generative model 212 also supports synthesis of images from given a text prompt—the model allows existing images to be re-drawn or altered (e.g., via inpainting, outpainting, etc.) to incorporate described elements. The image generative model 212, or one or more different component(s) of the image generation engine 210, may obtain pre-trained models and weights corresponding to the models.

For text-to-image generation, a specific seed value will affect the image that is output by the image generative model 212. Users may opt to randomize the seed to explore different generated outputs or use the same seed for deterministic output. A text prompt provided by a user guides the image's generation. The text prompt includes an identifier referencing the subject to be included in the image. Users may also specify the number of inference steps for a sampler associated with the image generative model 212. In general, more steps will take longer and produce higher quality output; fewer steps may result in visual defects. The image generative model 212 may provide another configurable parameter, a classifier-free guidance (CFG) scale value, which controls how closely the output image adheres to the text prompt. A higher value of the guidance scale may generate images that better match a prompt potentially at the cost of image quality or diversity.

Other use-cases for the image generative model 212 may include image upscaling, data anonymization and augmentation, image compression, inpainting, and outpainting.

An image generative model, such as a text-to-image diffusion model (e.g., Stable Diffusion), may be “customized” so that it is specialized to a user's image generation needs. Existing text-to-image models generally lack the ability to mimic the appearance of subjects in a reference set and synthesize novel renditions of them in different contexts. Given a particular subject, it is challenging for these models to generate photorealistic images of the subject contextualized in different scenes while maintaining high fidelity to its key visual features. Recent advances in text-conditional image synthesis have introduced techniques, such as Google's DreamBooth, for fine-tuning text-to-image models for subject-driven image generation. By leveraging existing text-to-image models, these techniques enable synthesizing a specific subject in diverse scenes, poses, views, lighting conditions, etc. that do not appear in the reference images.

DreamBooth is an exemplary fine-tuning algorithm. The algorithm takes as input a set of training images (e.g., 3-5 images) of a subject and the corresponding class name and returns a fine-tuned text-to-image model that encodes a unique identifier referring to the subject. Then, for inference based on the customized model, the unique identifier can be used to synthesize the subject in different contexts.

The training module 214 configures the tuning algorithm for the image generative model 212. In at least some embodiments, the training module 214 obtains a set of images for “regularization” for use in the tuning algorithm. Fine-tuning an image generation model can lead to overfitting to the context and appearance of the subject in the input images. Regularization is a technique for alleviating overfitting, allowing pose variability and appearance diversity in a given context. Specifically, the fine-tuning process is supervised with the model's own generated samples of the class noun, i.e., regularization images. In practice, this means that the model fits the input training images and the images sampled from visual prior of the non-fine-tuned class simultaneously. The regularization images are sampled and labeled using the class noun prompt.

For the training process, the training module 214 may receive, as input, a set of training images (e.g., subject's photos) and indications of a token name, a class name, number of regularization images, and training iterations. The token name may correspond to the unique identifier referencing the subject. The class name may be a generic class (e.g., man, woman, cat, dog, etc.) or specific instances of the class that are similar to the subject. The training iterations is a parameter defining the number of iterations to execute the model during the fine-tuning process. The fine-tuned model can then be used for inference, i.e., generating custom images of the subject.

The output image processing module 216 serves as a quality assurance layer for the fine-tuned text-to-image model. Images that are generated by the model may be processed by the output image processing module 216 to determine whether the output images are satisfactory, e.g., comply with defined criteria. In some embodiments, the output image processing module 216 may comprise machine learning models that are trained to detect certain image properties. The ML models may enable real-time evaluation of images and detection of anomalies, realism, etc. Additionally, the output image processing module 216 may serve a post-filter function that refines training data to filter for desirable properties in output images.

The network 250 is a computer network. In some embodiments, the network 250 may be an internetwork such as may be formed of one or more interconnected computer networks. For example, the network 250 may be or may include an Ethernet network, an asynchronous transfer mode (ATM) network, a wireless network, or the like.

In some example embodiments, the image generation engine 210 may be integrated as a component of an e-commerce platform. That is, an e-commerce platform may be configured to implement example embodiments of the image generation engine 210. More particularly, the subject matter of the present application, including example methods for AI-based image generation and customization of generative models as disclosed herein, may be employed in the specific context of e-commerce. By way of example, the disclosed methods may be implemented for generating and/or modifying images depicting products that are offered for sale on an e-commerce platform.

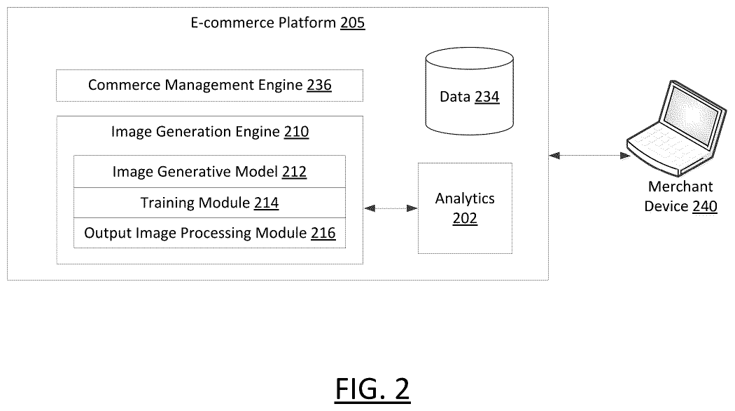

Reference is made to FIG. 2 which illustrates an example embodiment of an e-commerce platform 205 that implements an image generation engine 210. The merchant devices 240 may be communicably connected to the e-commerce platform 205. In at least some embodiments, the merchant devices 240 may be associated with accounts of the e-commerce platform 205. Specifically, the merchant devices 240 may be associated with individuals that have accounts in connection with the e-commerce platform 205. For example, the merchant devices 240 may be associated with merchants having one or more online stores on the e-commerce platform 205. The e-commerce platform 205 may store indications of associations between the merchant devices 240 and merchants of the e-commerce platform, for example, in the data facility 134.

The e-commerce platform 205 includes a commerce management engine 236, an image generation engine 210, a data facility 234, and a data store 202 for analytics. The commerce management engine 236 may be configured to handle various operations in connection with e-commerce accounts that are associated with the e-commerce platform 205. For example, the commerce management engine 236 may be configured to retrieve e-commerce account information for various entities (e.g., merchants, customers, etc.) and historical account data, such as transaction events data, browsing history data, and the like, for selected e-commerce accounts.

The functionality described herein may be used in commerce to provide improved customer or buyer experiences. The e-commerce platform 205 may implement the functionality for any of a variety of different applications, examples of which are described herein. Although the image generation engine 210 of FIG. 2 is illustrated as a distinct component of the e-commerce platform 205, this is only an example. An engine could also or instead be provided by another component residing within or external to the e-commerce platform 205. In some embodiments, one or more applications that are associated with the e-commerce platform 205 may provide an engine that implements the functionality described herein to make it available to customers and/or to merchants. Furthermore, in some embodiments, the commerce management engine 236 may provide that engine. However, the location of the image generation engine 210 may be implementation specific. In some implementations, the image generation engine 210 may be provided at least in part by an e-commerce platform, either as a core function of the e-commerce platform or as an application or service supported by or communicating with the e-commerce platform. Alternatively, the image generation engine 210 may be implemented as a stand-alone service to clients such as a customer's AR device. For example, an AR device could store and run an engine locally as a software application.

The image generation engine 210 is configured to implement at least some of the functionality described herein. Although the embodiments described below may be implemented in association with an e-commerce platform, such as (but not limited to) the e-commerce platform 205, the embodiments described below are not limited to e-commerce platforms.

The data facility 234 may store data collected by the e-commerce platform 205 based on the interaction of merchants and customers with the e-commerce platform 205. For example, merchants provide data through their online sales activity. Examples of merchant data for a merchant include, without limitation, merchant identifying information, product data for products offered for sale, online store settings, geographical regions of sales activity, historical sales data, and inventory locations. Customer data, or data which is based on the interaction of customers and prospective purchasers with the e-commerce platform 205, may also be collected and stored in the data facility 234. Such customer data is obtained based on inputs received via AR devices associated with the customers and/or prospective purchasers. By way of example, historical transaction events data including details of purchase transaction events by customers on the e-commerce platform 205 may be recorded and such transaction events data may be considered customer data. Such transaction events data may indicate product identifiers, date/time of purchase, final sale price, purchaser information (including geographical region of customer), and payment method details, among others. Other data vis-à-vis the use of e-commerce platform 205 by merchants and customers (or prospective purchasers) may be collected and stored in the data facility 234.

The data facility 234 may include customer preference data for customers of the e-commerce platform 205. For example, the data facility 234 may store account information, order history, browsing history, and the like, for each customer having an account associated with the e-commerce platform 205. The data facility 234 may additionally store, for a plurality of e-commerce accounts, wish list data and cart content data for one or more virtual shopping carts. The data facility 234 may include merchant preference data for merchants selling their products on the e-commerce platform 205.

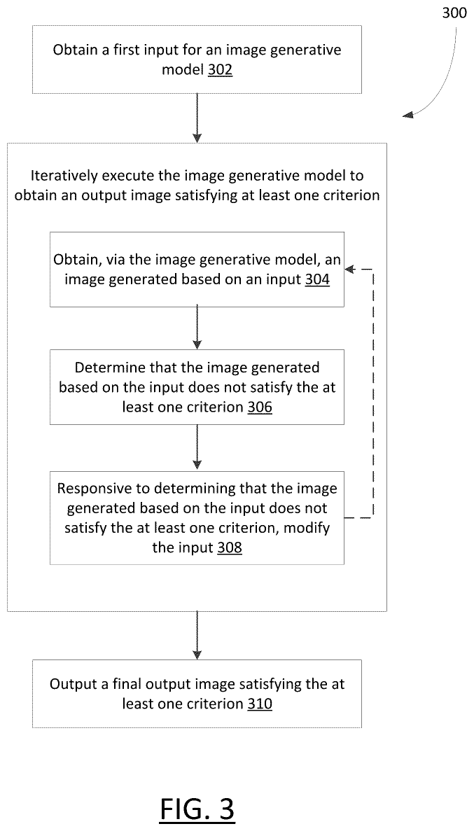

Reference is now made to FIG. 3, which shows, in flowchart form, an example method 300 for generating subject-driven images based on an image generative model. Specifically, the method 300 may enable controlling output of an image synthesis process. The method 300 may be performed by a computing system or engine that supports AI-based generation of images, such as the image generation engine 210 of FIG. 1. As detailed above, an image generation engine may be a service that is provided within or external to an e-commerce platform. An image generation engine may implement the operations of method 300 as part of a quality assurance process for a customized text-to-image model.

As described above, a pre-trained image generative model, such as a latent diffusion model like Stable Diffusion, may be customized such that the model can be used to synthesize images of a subject contextualized in different scenes. Specifically, a text-to-image framework may be fine-tuned to enable users to capture photos of a subject and generate novel renditions of the subject in different contexts, while maintaining fidelity to its key visual features. The fine-tuned model can then be used to generate images of the subject based on conditioning text prompts.

In operation 302, the image generation engine obtains a first input for an image generative model. The first input may comprise values of parameters that are input to the customized generative model. In at least some embodiments, the first input includes a text prompt that guides the generation of specific imagery. The text prompt may, for example, be a natural language description of images that are desired to be produced using the customized generative model. As the model is fine-tuned to generate images of a specific subject, the text prompt may include a reference to the subject. For example, the text prompt may indicate a token name that references the subject. In some embodiments, the text prompt may also include a “negative prompt”. A negative prompt may be used to specify what is desired to not be depicted in the generated images.

The first input may include additional parameter values for indicating user preferences or desired image properties. For example, the first input may include values of, among others, a number of images that the model will generate in a single batch, a guidance scale (for controlling how much importance is given to the input text prompt), a number of inference steps that the model will run, and dimensions (i.e., height and width) of the images to be generated.

The image generation engine iteratively executes the customized generative model to obtain an output image satisfying certain defined criteria. The criteria may be defined by users of the image generative model. In particular, users may define rules or conditions relating to synthetic images such as image quality, perceived photorealism, semantic alignment with text prompts, etc., The images that are generated throughout the iterative process may then be assessed based on the defined rules. The final output image may be an image generated by the customized generative model that complies with all or at least a threshold number of the rules or conditions. Additionally, or alternatively, the criteria may include rules that are designed for ensuring image realism. As will be explained in greater detail below, these rules may be used to automatically detect whether the depiction of the subject in the generated images contains defects or anomalies that adversely affect the realism of the images.

In operation 304, the image generation engine obtains, via the customized generative model, an image generated based on an input. In the initial iteration, the input to the model comprises the first input. The output of this initial generative step is then assessed by a quality assurance layer associated with the image generation engine. Specifically, the image generation engine determines whether the sample generated based on the input satisfies the defined criteria, in operation 306.

In at least some embodiments, one or more machine learning models may be employed by the image generation engine for analyzing the generated sample. The determination of whether the generated sample satisfies a criterion may depend on the output of the machine learning model(s). The machine learning models may be trained to detect specific properties of subjects that are depicted in images inputted to the models. In particular, various image processing models, such as those based on convolutional neural networks (CNNs), may be used for determining whether the generated sample features any defects or anomalies.

By way of example, a model that is trained for human pose estimation may be leveraged by the image generation engine. Pose estimation refers to computer vision techniques for detecting the pose (i.e., position and orientation) of a person from an image, by estimating the spatial locations of key body joints and parts, or keypoints. A pose estimation model takes an image of a subject as input and outputs information about keypoints of the subject. Specifically, the precise locations of keypoints may be determined (and predicted) using a pose estimation model. The output of a pose estimator may include estimated coordinates of detected body parts and joints in the input image and confidence scores associated with the estimates. If the subject that is depicted in the image generated by the customized model is a human, the image generation engine may combine information about typical poses of humans and the output of a pose estimator to identify any anomalies associated with the pose and/or body parts of the depicted subject. For example, the image generation engine may be able to identify impossible or unlikely poses, incorrect number of limbs or digits, erroneous positions of limbs or digits, skeletal misalignment, etc., based on analysis of the generated sample using outputs of the pose estimator.

As another example, a machine learning model that is trained for detecting structural features of an object, such as a product, may be used in analyzing output of the customized image generation. The model may, for example, be a pre-trained model that is trained to recognize a specific object, or category of objects, using a reference set of sample photos depicting the object(s). The model may facilitate analysis of the generated sample by identifying features (e.g., edges, corners, etc.) or patterns of the object in the generated sample that are structurally anomalous for the object.

As yet another example, a pre-trained text recognition model may be used to analyze text that is depicted in a generated sample. The model may be configured to identify typed, handwritten, or printed text in an image, for example, through optical character recognition. If the text recognized by the model comprises non-words and/or nonsense characters, the image generation engine may determine that an anomaly is detected. In some embodiments, the image generation engine may compare the recognized text with words or phrases that are expected to be depicted on a subject (e.g., product information on packaging or label) in determining whether the generated sample contains a text anomaly.

The image generation engine may leverage other computer vision models/algorithms to derive information about a generated sample. The models may be trained to determine one or more of: an indicator of photorealism associated with the generated sample; structural anomalies in subjects in the generated sample; or lighting anomalies on the subjects and/or scene depicted in the generated sample. For example, a trained model may be used to detect information about specularities and shadows in a generated sample, such as their locations, sizes, etc. The generated sample may be further analyzed, for example, by a lighting estimation model to obtain information about the lighting in the scene depicted in the image. For example, a lighting estimator may determine lighting cues such as ambient light, reflections, shading, etc. and predict lighting conditions for the scene. The lighting estimation for the image may then be compared with the detected shadows/specularities to determine whether there are inconsistencies with lighting on the subject and/or scene.

In some embodiments, a machine learning model may be trained to assign aesthetics scores to the samples that are generated using the customized generative model. For example, a pre-trained model may be configured to process generated samples to derive, for each sample, a predicted aesthetics score representing a subjective visual quality of the sample.

If the image generation engine detects an anomaly in an output of the customized generative model, it may determine that a related criterion has not been satisfied by the generated sample. For example, the defined criteria for assessing a generated sample may include rules requiring absence of anomalies associated with subjects or scenes depicted in the image. That is, the defined criteria may identify certain defects to check for when analyzing the output of image generation. Upon detecting an anomaly (e.g., a subject in an impossible pose) based on, for example, output of the machine learning models, the image generation engine may determine that the generated sample does not satisfy at least one related criterion (e.g., pose requirement of human subjects).

In response to determining that the image generated based on an input does not satisfy at least one criterion, the image generation engine modifies the input, at operation 308. Specifically, the image generation engine determines a modified input to the customized generative model for a next iteration of generation. In at least some embodiments, modifying the input may include modifying a text prompt. The image generation engine may be configured to automatically modify text prompts or present, to a user, suggestions for modifying text prompts between iterations of the generative process.

The modifications to the text prompt may be determined based on at least one anomaly associated with the sample generated in the previous iteration. In some embodiments, the modifications to the text prompt may be determined based on a mapping between a set of one or more defined modification text and types of anomalies detectable in images generated via the customized generative model. For example, if a detected anomaly in a generated sample relates to the number of fingers of a human subject, a corresponding modification text may comprise “with five fingers”. The text prompt may then be automatically modified to include this modification text. As another example, upon detecting a defect in light projections and/or shadows in a generated sample, a corresponding modification text such as “with correct shadow of [subject]” or “with consistent light and shadow conditions” may be included in the modified text prompt. In some embodiments, the image generation engine may provide suggested modification text to a user and prompt the user for input of a modified text prompt. The suggested modification text may be selected based on, at least, an anomaly that is detected in the generated sample of the previous iteration. A description of the detected anomaly may be provided along with the suggested language to indicate to the user the nature of the ostensible problem with the generated sample.

The image generation engine may be configured to test various types of prompt modifications. A text prompt may be modified to, for example, include both a token name and a class name in the prompt, change an order of the words in the prompt, repeat one or more words in the prompt, add certain defined adjectives or adverbs, etc.

Additionally, or alternatively, modifying the input may include changing a seed value, i.e., using a different seed. The seed may be automatically generated either randomly or according to defined rules for changing the seed. Other parameter values such as number of samples, guidance scale, number of inference steps, and image dimensions may be varied as part of modifying the input to the customized generative model. Each modified input represents a different combination of variations of the parameter values and corresponds to an independent iteration of the generative process.

The iteratively executing is repeated until an image is obtained based on the first input that satisfies the at least one criterion. In particular, a modified input in operation 308 of an iteration may be input to the image generative model at operation 304 of the subsequent iteration (shown by stippled lines in FIG. 3). An image that satisfies the at least one criterion is provided as the final output image (operation 310). In some embodiments, a first output that satisfies all defined criteria may be designated as the final output image. That is, the final output image may be the first instance of an output image that satisfies all defined criteria. Upon identifying said final output, the iterative generation process of method 300 may be ended.

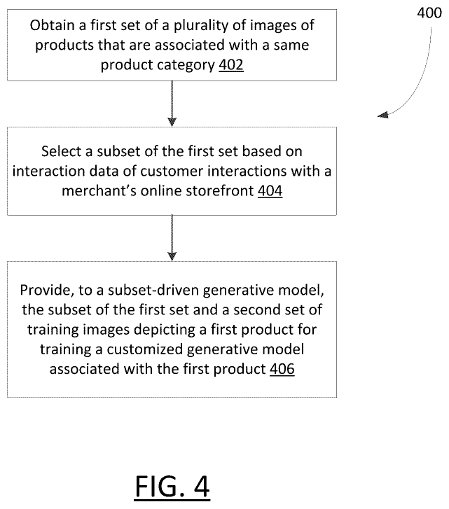

Reference is now made to FIG. 4, which shows, in flowchart form, an example method 400 for customized training of an image generative model. The method 400 may be performed by a computing system or engine that supports AI-based generation of images, such as the image generation engine 210 of FIG. 1. As detailed above, an image generation engine may be a service that is provided within or external to an e-commerce platform. An image generation engine may implement the operations of method 400 as part of a quality assurance process for a customized text-to-image model. The operations of method 400 may be performed in addition to, or as alternatives of, one or more operations of method 300.

A text-to-image generative model may be fine-tuned, or customized, to enable synthesizing a specific subject in diverse scenes. The model may be trained using a small number of reference images of the subject and a set of regularization images. The fine-tuning algorithm employs class-specific prior-preservation loss which acts as a regularizer that alleviates overfitting and language drift issues. The regularization images are samples of the class noun associated with the subject that are generated by the model.

In some implementations, the selection of regularization images for use in training the customized generative model may be controlled to enable biasing the generation of images by the model. As a particular example, a customized generative model may be used for synthesizing product images featuring a specific product. The regularization images for training the model may be selected based on defined product- and/or merchant-specific criteria relating to merchant preferences, customer interaction data, and the like. That is, the selection of the regularization set may be guided by product- or merchant-related data.

In operation 402, the image generation engine obtains a first set of a plurality of images of products that are associated with a same product category, i.e., class noun associated with a specific product. In particular, the first set includes only those images of products that belong to a same product category. The product category may, for example, be one of a defined list of categories of consumer products. The image generation engine then selects a subset of the first set based on interaction data of customer interactions with a merchant's online storefront, in operation 404. Specifically, the interaction data may comprise information describing customers' interactions with products of the product category on a mobile app, website, etc.

The interactions may include product search, click-through (e.g., from a product search page or listing), page visits, shopping cart updates, product purchases, image and/or video views, and the like. The interaction data may include, for example, dwell time data, clickthrough rate data, sales conversion rate, etc. The interaction data may provide an indication of product images or image properties and features that are associated with greater clickthrough rate, dwell time, conversion. The product images or image properties/features that are identified as being favorable for sales of the product are then used to guide the selection of the regularization images for training the customized generative model. For example, the image generation engine may identify popular products of a merchant and determine product images or image properties/features of the product that are associated with interaction data indicating higher customer preference. The first set of images may be analyzed to determine which of the images is associated with the identified popular products, product images, and image properties/features. The image generation engine may, for example, process photo metadata of photos of the first set and compare against the identified information indicating customer preference in selecting the subset of the first set.

In operation 406, the image generation engine provides, to a deep learning generative model (i.e., algorithm for fine-tuning text-to-image model), the subset of the first set and a second set of reference images depicting a first product for training a customized generative model associated with the first product. The deep learning generative model is configured to fine-tune a text-to-image diffusion model for training the customized generative model associated with the first product. The subset represents the set of regularization images that are selected from the same product category as the first product.

In some embodiments, the image generation engine may receive a first input and obtain, via the customized generative model associated with the first product, a first output image based on providing the first input to the customized generative model. The input may, for example, comprise natural language description of a desired output.

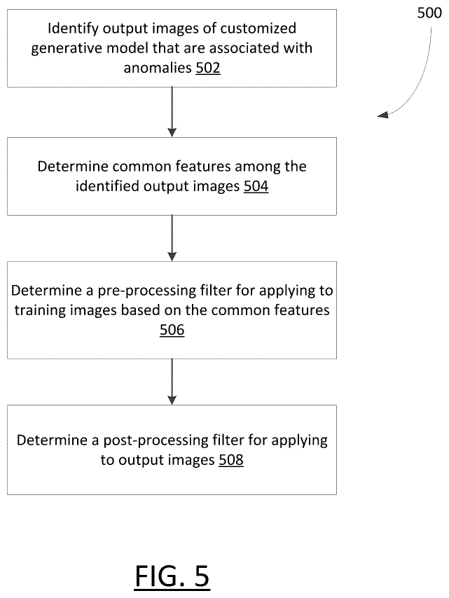

Reference is now made to FIG. 5, which shows, in flowchart form, another example method 500 for generating subject-driven images based on an image generative model. The method 500 may be performed by a computing system or engine that supports AI-based generation of images, such as the image generation engine 210 of FIG. 1. As detailed above, an image generation engine may be a service that is provided within or external to an e-commerce platform. An image generation engine may implement the operations of method 500 as part of a quality assurance process for a customized text-to-image model. The operations of method 500 may be performed in addition to, or as alternatives of, one or more of the operations of methods 300 and 400.

In some implementations, the image generation engine may determine filters for applying to either training, or reference, images or output samples of a customized text-to-image generative model. The filters may, for example, be pre- and post-processing filters that are designed to be applied automatically to ensure successive refining and customization of the model.

The image generation engine obtains, via the customized generative model, sample images that are generated based on an input text prompt. In a similar manner as described above with respect to method 300, the generative process may be executed iteratively until a satisfactory final output image is obtained. Specifically, the customized generative model may be iteratively executed to obtain an output image that satisfies all or at least a threshold number of defined output-related criteria. The image generation engine identifies the sample images that are associated with detected anomalies, in operation 502. That is, for those iterations where the generated sample contains an anomaly in the depiction of a subject and/or scene, the sample images, or rejected samples, may be collected by the image generation engine.

In operation 504, the image generation engine determines common features among the identified rejected samples. In some embodiments, the criteria that the rejected samples failed to satisfy may be determined. The criteria may relate to any one or more of subject or scene anomaly detection, image quality, perceived photorealism, semantic alignment with text prompts, and the like. The image generation engine may then determine a pre-processing filter for applying to training image based on the common features and/or the failed criteria, in operation 506. For example, the pre-processing filter may be used in refining an initial set of reference images for training the customized generative model. That is, an initial reference image set may be pared down based on analysis of the images using the pre-processing filter. Only the remaining reference images after application of the pre-processing filter may be used to train the customized generative model. Additionally, or alternatively, the pre-processing filter may inform the direct editing or modifying of reference images prior to the training. In particular, the image generation engine may be configured to edit or alter image properties of one or more reference images based on criteria identified in the pre-processing filter.

The pre-processing filter may also be used to identify other parameters that are conducive to refining the customized generative model. For example, the pre-processing filter may include indications of text prompts that are associated with detected anomalies or defects in generated samples, as well as suggestions for replacing such problematic text prompts. The suggestions may, for example, include modification text that is suitable for use in replacing one or more elements of the text prompts associated with the rejected samples.

Further, in operation 508, the image generation engine determines a post-processing filter for applying to a final output image. The post-processing filter may comprise modifications to a final output for desirable image properties. In the context of e-commerce, the post-processing filter may be determined based on product- or merchant-related data such as merchant preferences, customer interaction data, etc., and outputs of the customized generative model may be automatically manipulated using the post-processing filter.

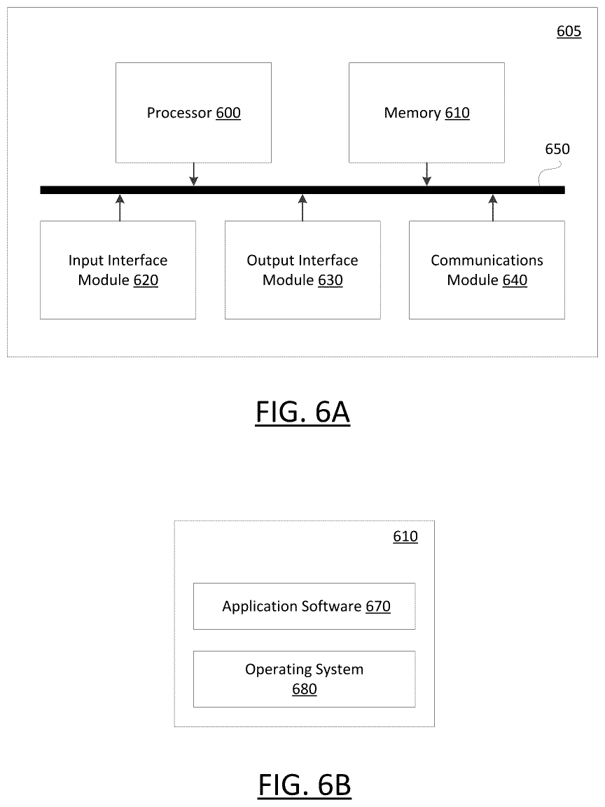

The above-described methods may be implemented by way of a suitably programmed computing device. FIG. 6A is a high-level operation diagram of an example computing device 605. The example computing device 605 includes a variety of modules. For example, as illustrated, the example computing device 605, may include a processor 600, a memory 610, an input interface module 620, an output interface module 630, and a communications module 640. As illustrated, the foregoing example modules of the example computing device 605 are in communication over a bus 650.

The processor 600 is a hardware processor. The processor 600 may, for example, be one or more ARM, Intel x86, PowerPC processors or the like.

The memory 610 allows data to be stored and retrieved. The memory 610 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 605.

The input interface module 620 allows the example computing device 605 to receive input signals. Input signals may, for example, correspond to input received from a user. The input interface module 620 may serve to interconnect the example computing device 605 with one or more input devices. Input signals may be received from input devices by the input interface module 620. Input devices may, for example, include one or more of a touchscreen input, keyboard, trackball or the like. In some embodiments, all or a portion of the input interface module 620 may be integrated with an input device. For example, the input interface module 620 may be integrated with one of the aforementioned examples of input devices.

The output interface module 630 allows the example computing device 605 to provide output signals. Some output signals may, for example allow provision of output to a user. The output interface module 630 may serve to interconnect the example computing device 605 with one or more output devices. Output signals may be sent to output devices by output interface module 630. Output devices may include, for example, a display screen such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface module 630 may be integrated with an output device. For example, the output interface module 630 may be integrated with one of the aforementioned example output devices.

The communications module 640 allows the example computing device 605 to communicate with other electronic devices and/or various communications networks. For example, the communications module 640 may allow the example computing device 605 to send or receive communications signals. Communications signals may be sent or received according to one or more protocols or according to one or more standards. For example, the communications module 640 may allow the example computing device 605 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 640 may allow the example computing device 605 to communicate using near-field communication (NFC), via Wi-Fi™, using Bluetooth™ or via some combination of one or more networks or protocols. Contactless payments may be made using NFC. In some embodiments, all or a portion of the communications module 640 may be integrated into a component of the example computing device 605. For example, the communications module may be integrated into a communications chipset.

Software comprising instructions is executed by the processor 600 from a computer-readable medium. For example, software may be loaded into random-access memory from persistent storage of memory 610. Additionally, or alternatively, instructions may be executed by the processor 600 directly from read-only memory of memory 610.

FIG. 6B depicts a simplified organization of software components stored in memory 610 of the example computing device 605. As illustrated these software components include an operating system 680 and application software 670.

The operating system 680 is software. The operating system 680 allows the application software 670 to access the processor 600, the memory 610, the input interface module 620, the output interface module 630, and the communications module 640. The operating system 680 may be, for example, Apple™ OS X, Android™, Microsoft™ Windows™, a Linux distribution, or the like.

The application software 670 adapts the example computing device 605, in combination with the operating system 680, to operate as a device performing particular functions.

### Example E-Commerce Platform

Although not required, in some embodiments, the methods disclosed herein may be performed on or in association with an e-commerce platform. An example of an e-commerce platform will now be described.

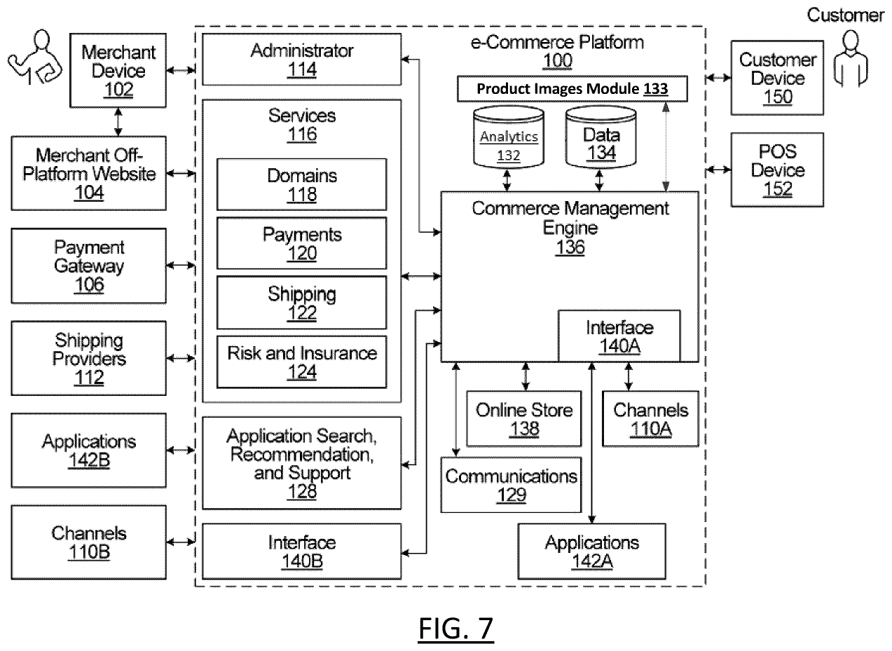

FIG. 7 illustrates an example e-commerce platform 100, according to one embodiment. The e-commerce platform 100 may be exemplary of the e-commerce platform 205 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as an AR device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure, the terms online store and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to AR devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings that may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

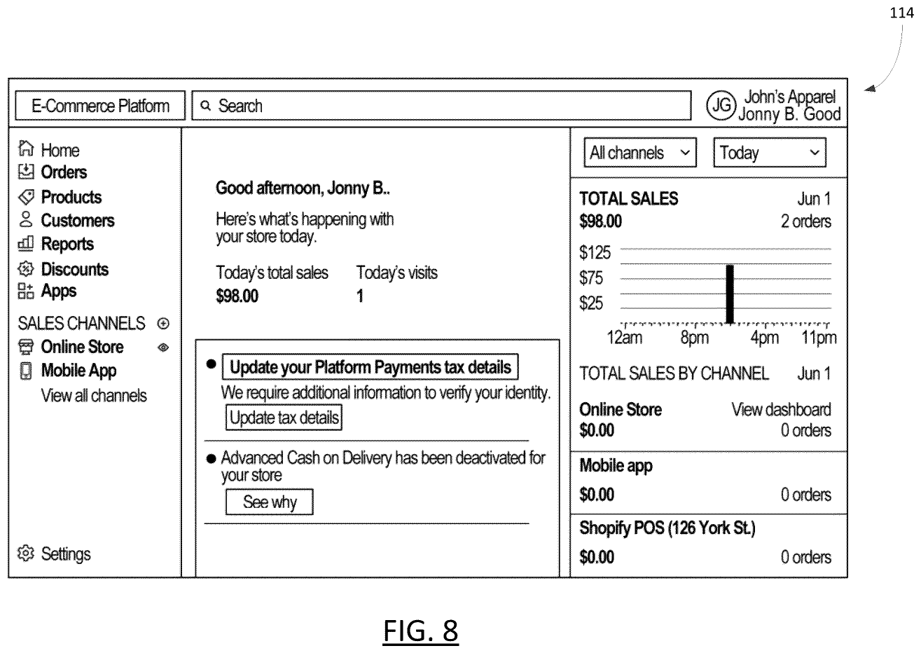

FIG. 8 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 8. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

The e-commerce platform 100 may implement a product images module 133 which may be configured to support at least some of the functions of the image generation engine 210 of FIG. 2 described above.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining a first input for an image generative model;
iteratively executing the image generative model to obtain an output image satisfying at least one criterion, the iteratively executing including:
obtaining, via the image generative model, an image generated based on an input;
determining that the image generated based on the input does not satisfy the at least one criterion;
responsive to determining that the image generated based on the input does not satisfy the at least one criterion, modifying the input,
wherein the iteratively executing is repeated until an image is obtained based on the first input that satisfies the at least one criterion.

2. The method of claim 1, wherein the obtained image that satisfies the at least one criterion is provided as the output image.

3. The method of claim 1, wherein determining that the image generated based on the input does not satisfy the at least one criterion includes using a machine learning model to analyze the image.

4. The method of claim 3, wherein the machine learning model provides an evaluation of an input image corresponding to the at least one criterion.

5. The method of claim 4, wherein the machine learning model is trained to determine at least one of:
poses of human subjects in a generated image;
an indicator of photorealism associated with the generated image;
structural anomalies in subjects in the generated image; or
lighting anomalies on the subjects or scene depicted in the generated image.

6. The method of claim 4, wherein the machine learning model is trained to assign aesthetics scores to generated images.

7. The method of claim 1, wherein modifying the input comprises at least one of modifying a text prompt or changing a seed value associated with the image generative model.

8. The method of claim 7, wherein modifications to the text prompt are determined based on at least one anomaly associated with the image generated based on the input.

9. The method of claim 7, wherein modifications to the input are determined based on a mapping between a set of one or more defined modification text and types of anomalies detectable in images generated via the image generative model.

10. The method of claim 1, further comprising:
obtaining, via the image generative model, one or more further output images that are associated with detected anomalies; and
determining a pre-processing filter for applying to training image sets that are inputted to the image generative model, the pre-processing filter being constructed based on the further output images.

11. The method of claim 10, wherein the pre-processing filter comprises an aesthetics scoring model for assigning aesthetics scores to images of a training image set.

12. A computer-implemented method, comprising:
obtaining a first set of a plurality of images of products that are associated with a same product category;
selecting a subset of the first set based on interaction data of customer interactions with a merchant's online storefront; and
providing, to a deep learning generative model, the subset of the first set and a second set of training images depicting a first product for training a customized generative model associated with the first product.

13. The method of claim 12, wherein the interaction data comprises at least one of dwell time data or clickthrough rate data.

14. The method of claim 12, further comprising:
receiving a first input; and
obtaining, via the customized generative model associated with the first product, a first output image based on providing the first input to the customized generative model.

15. The method of claim 14, wherein the first input comprises natural language description of a desired output.

16. The method of claim 12, wherein the deep learning generative model is configured to fine-tune a text-to-image diffusion model for training the customized generative model associated with the first product.

17. A computing system, comprising:
a processor; and
memory coupled to the processor, the memory storing computer-executable instructions that, when executed by the processor, configure the processor to:
obtain a first input for an image generative model;
iteratively execute the image generative model to obtain an output image satisfying at least one criterion, the iteratively executing including:
obtaining, via the image generative model, an image generated based on an input;
determining that the image generated based on the input does not satisfy the at least one criterion;
responsive to determining that the image generated based on the input does not satisfy the at least one criterion, modifying the input,
wherein the iteratively executing is repeated until an image is obtained based on the first input that satisfies the at least one criterion.

18. The computing system of claim 17, wherein the obtained image that satisfies the at least one criterion is provided as the output image.

19. The computing system of claim 17, wherein determining that the image generated based on the input does not satisfy the at least one criterion includes using a machine learning model to analyze the image.

20. A non-transitory processor-readable medium storing processor-executable instructions that, when executed by a processor, are to cause the processor to:
obtain a first input for an image generative model;
iteratively execute the image generative model to obtain an output image satisfying at least one criterion, the iteratively executing including:
obtaining, via the image generative model, an image generated based on an input;
determining that the image generated based on the input does not satisfy the at least one criterion;
responsive to determining that the image generated based on the input does not satisfy the at least one criterion, modifying the input,
wherein the iteratively executing is repeated until an image is obtained based on the first input that satisfies the at least one criterion.
